(19) United States
(12) Patent Application Publication
(10) Pub. No.: US 2008/0303758 A1
(43) Pub. Date: Dec. 11, 2008

(54) Display Device

(76) Inventors: Yoshihisa Ooishi, Yokohama (JP); Junichi Maruyama, Yokohama (JP); Takashi Shoji, Fujisawa (JP); Kikuo Ono, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/131,202

(22) Filed: Jun. 2, 2008

(30) Foreign Application Priority Data
Jun. 8, 2007 (JP) 2007-152693

(51) Int. Cl. G09G 3/34

(52) U.S. Cl. 345/84

(57) ABSTRACT

High-order bits to be utilized for current-frame display data and previous-frame display data, and low-order bits to be utilized for the current-frame display data alone are stored in independently controllable memory areas. For reading the current-frame display data from a frame memory, data of the high-order bits and data of the low-order bits are read. For reading the previous-frame data, the high-order bits alone are read. Thus, since a period during which the data of the low-order bits that is not utilized for the previous-frame display data is stored in the memory is shortened, a required memory capacity can be reduced. The data transfer time can be reduced by the time required for memory read for the data of the low-order bits that is not utilized for the previous-frame display data.

### CLAIM OF PRIORITY

The present application claims priority from Japanese application serial No. 2007-152693 filed on Jun. 8, 2007, the content of which is hereby incorporated by reference into this application.

### BACKGROUND OF THE INVENTION

1. Field of the Invention

The present invention relates to a display device such as a liquid crystal display that utilizes a frame memory, or more particularly, to frame memory control.

2. Background Art

Active matrix type liquid crystal display devices are utilized as display devices for thin-screen televisions or the like owing to the features of a thin screen, high definition, and low power consumption. However, the optical response of a liquid crystal requires about several tens of milliseconds, that is, a time longer than a scan period (one frame) for one screen. When a motion picture is displayed, the response of the liquid crystal cannot catch up with a change in display data. This results in blurred display. Known as measures against the blurring are a method (hereinafter called a conventional method 1) of, as mentioned in JP-A-2006-292972, dividing one frame into multiple sub-frames (hereinafter may be called fields), controlling a gray scale for each of the fields, and thus suppressing motion-picture blurring, and a method (hereinafter called a conventional method 2) of, as mentioned in JP-A-2005-352155, sensing a change in image data per a pixel, correcting a voltage to be applied to a liquid crystal according to the change, and thus improving the optical response of the liquid crystal.

Assuming that the background technologies are utilized, both the two methods utilize a frame memory and store display data and data of a previous frame in the frame memory. Therefore, especially, if the number of display pixels increases, the memory capacity and the traffic to or from the memory increase. This leads to a rise in the cost of a display device. In the conventional method 2, since the data stored in the frame memory is utilized for arithmetic operations, a method of improving the optical response of a liquid crystal using a memory capacity of one screen image or less for the purpose of reducing the cost is implemented. However, when the conventional method 1 and conventional method 2 are combined, the conventional method 1 often does not permit degradation in image quality caused by data compression because display data stored in the frame memory is displayed on a display panel. A reduction in the memory capacity to be achieved through data compression cannot be adapted to memory access to be gained according to the combination of the conventional methods 1 and 2 (data written once is read for n frames (where n denotes 2 or more). When memory accesses are mutually independently gained according to the two methods, the traffic to the frame memory becomes enormous.

### SUMMARY OF THE INVENTION

In order to solve the above problem, according to the present invention, data A to be used in both the conventional methods 1 and 2, and data B to be used in the conventional method 1 alone are stored independently in controllable memory areas. In the present invention, when display data is read according to the conventional method 1, all of the data A and data B is read out. When display data is read according to the conventional method 2, the data A alone is read out. Since the data B is not used after display frame data is read, the data B is overwritten.

According to the present invention, when the conventional method 1 is implemented, all bits of gray-scale data are utilized. However, when the conventional method 2 is implemented, all the bits are not utilized but high-order bits that greatly dominate a gray level are utilized. Specifically, although high-order bits that greatly dominate a gray level are utilized in both the conventional methods 1 and 2, low-order bits that little dominate the gray level are, in the present invention, used only to implement the conventional method 1 but are not used to implement the conventional method 2.

In the present invention, input display data to be sequentially transferred frame by frame is divided into high-order bits and low-order bits, and the high-order bits and low-order bits are stored in an address area in a frame memory. The high-order bits are read at the time of utilizing current-frame display data and previous-frame display data, and the low-order bits are read at the time of utilizing the current-frame display data.

When the conventional method 2 is implemented, the lower-order bits are not utilized in the present invention. Therefore, the period during which the low-order bits are stored in a memory is shortened, and the memory capacity is therefore reduced. Moreover, the data transfer time needed to read the low-order bits from the memory can be minimized.

Consequently, according to the present invention, the traffic to or from a frame memory can be reduced, and a required memory capacity can be reduced. Therefore, in a display device that adopts as a frame memory a memory IC for which a data bus, a transfer rate, and a memory capacity are defined on a general-purpose basis, the number of memory ICs can be decreased, or a relatively inexpensive slow-transfer memory IC can be substituted for an expensive fast-transfer memory IC. Eventually, the cost of the display device can be reduced. The present invention is applied to liquid-crystal televisions and liquid-crystal displays.

### BRIEF DESCRIPTION OF THE DRAWINGS

FIG. 1 is a block diagram showing the configuration of a display device in accordance with the present invention;

FIG. 2 is a timing chart concerning the display device shown in FIG. 1;

FIG. 3A to FIG. 3D are explanatory diagrams showing the configuration of a frame memory 104 shown in FIG. 1, and the operations thereof;

FIG. 4A to FIG. 4D show examples of address maps in the frame memory 104 shown in FIG. 1;

FIG. 5 is a command production timing chart relevant to a frame memory control unit 105 shown in FIG. 1.

### DETAILED DESCRIPTION OF THE INVENTION

Referring to the drawings, embodiments of the present invention will be described below.

### Embodiment 1

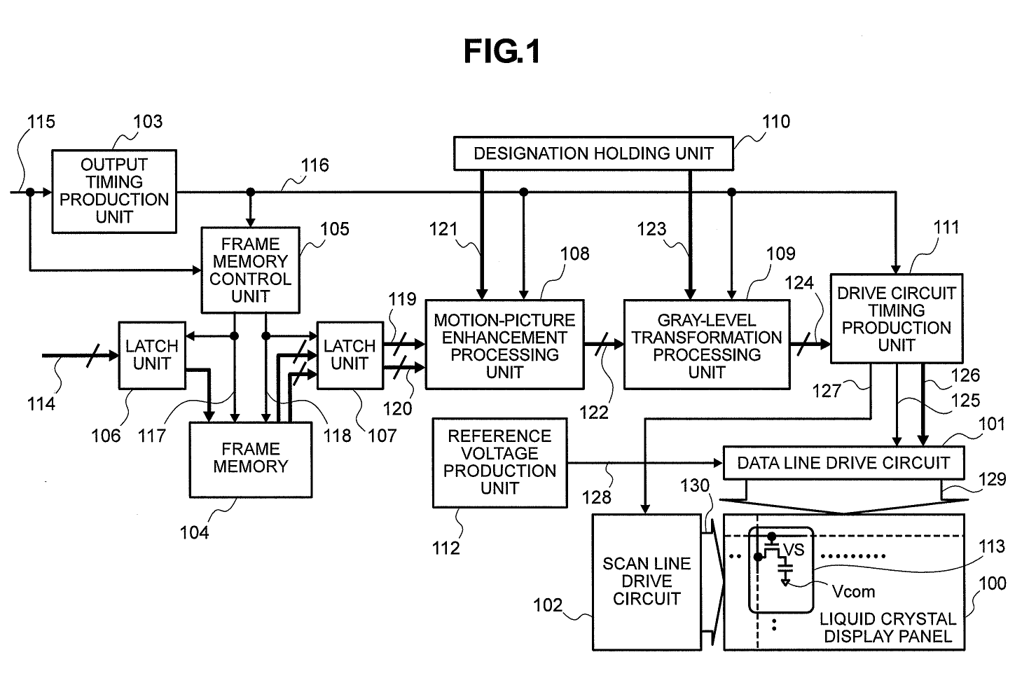

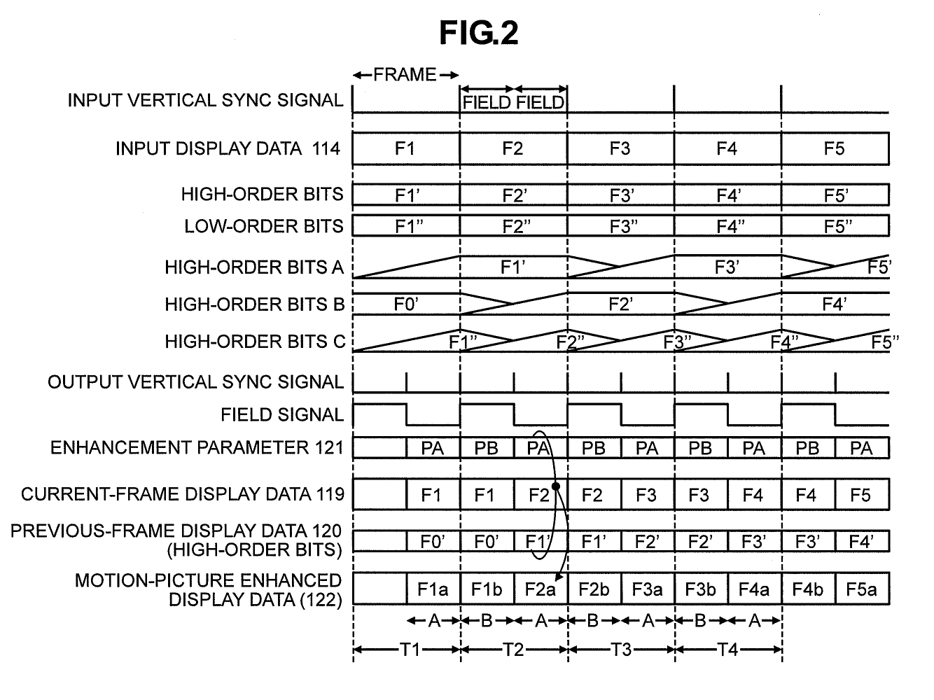

FIG. 1 is a block diagram showing the configuration of a display device in accordance with the present invention. Herein, the display device will be described by taking a liquid crystal display device for instance. FIG. 2 is a timing chart showing an example of the operation of the display device shown in FIG. 1.

As shown in FIG. 1, the display device of the present embodiment includes: an output timing production unit 103 that produces an output timing signal, of which cycle is repeated at a frequency that is n times higher than the frame frequency of input display data, so as to drive a liquid crystal panel 100, a data line drive circuit 101, and a scan line drive circuit 102 at a frame frequency that is n (n≦2) times higher than the frame frequency of the input display data; a frame memory 104 in which the input display data is temporarily stored; a frame memory control unit 105 that controls reading and writing of the input display data from and in the frame memory 104; a latch unit 106 that is used to rearrange the bits of the input display data to be stored in the frame memory 104; a latch unit 107 that rearrange the bits of the display data, which has been rearranged by the latch unit 106 and read from the frame memory 104, so as to restore the original arrangement; a motion picture enhancement processing unit 108 that enhances a motion-picture part of display data; a gray-level transformation processing unit 109 that modifies the gray-scale characteristic for each frame to be repeated at the frequency that is n times higher (hereinafter called a field. In case where n in “n times higher” equals 2, field A and field B); a designation holding unit 110 that holds designated values based on which pieces of processing to be performed by the motion picture enhancement processing unit 108 and gray-level transformation processing unit 109 respectively are modified; a drive circuit timing production unit 111 that produces signals for use in operating the data line drive circuit 101 and scan line drive circuit 102 respectively; a reference voltage production unit 112 that produces a reference voltage to be used as a reference when the data line drive circuit 101 produces a gray-level voltage; the data line drive circuit 101 that feeds a gray-scale voltage proportional to display data to any of data lines in the liquid crystal panel 100; the scan line drive circuit 102 that feeds a scan selection signal to any of scan lines in the liquid crystal panel 100; and the liquid crystal display panel 100 having a plurality of pixels 113 arrayed in the form of a matrix at intersections between the multiple data lines and the multiple scan lines.

In FIG. 1, the display device of the present embodiment inputs input display data 114 and an input timing signal group 115, makes a frame frequency n times higher, and displays display data on the liquid crystal panel 100 through driving to which motion-picture enhancement is adapted.

The input timing signal group 115 includes, for example, a vertical synchronizing (hereinafter sync) signal that defines one frame period (period during which input display data for one screen is displayed), a horizontal sync signal that defines one horizontal scan period (period during which input display data for one line is displayed), a data effective period signal that defines an effective period of input display data, and a reference clock synchronous with the input display data.

The input display data 114 and input timing signal group 115 are transferred from an external system (for example, a reception/signal processing unit of a television, a PC body, or a microprocessor (MPU) of a portable cellular phone). The input display data 114 is display data for one screen to be displayed during one frame period, and is sequentially transferred as a set of display pixel color units (for example, 8-bit data of display pixel red) (for example, a set of two pixel data items having a length of 48 bits that include 8-bit red data of an odd pixel, 8-bit green data of the odd pixel, 8-bit blue data of the odd pixel, 8-bit red data of an even pixel, 8-bit green data of the even pixel, and 8-bit blue data of the even pixel) from the external system synchronously with the reference clock.

The output timing production unit 103 is a circuit that produces an output timing signal group 116 of a frame frequency that is n times higher than that of the input timing signal group 115 serving as a reference.

The frame memory 104 is a circuit in which the input display data 114 is temporarily stored and from which display data is outputted synchronously with the output timing signal group 116. Preferably, a memory IC whose addresses can be mutually independently or successively controlled, such as, an inexpensive SRAM or DRAM is adopted as the frame memory 104.

The frame memory control unit 105 is a circuit that produces a memory write control command 117, with which writing of data in the frame memory 104 is controlled, and a memory read control command 118, with which reading of data from the frame memory 104 is controlled, using the input timing signal group 115 or output timing signal group 116 as a reference.

FIG. 2 is a timing chart relevant to the display device shown in FIG. 1, and shows an example of the timing of displaying input display data by making a frame frequency n times higher (n denotes 2). The axis of abscissas indicates times. Herein, the frame memory control unit 105 controls writing of display data, which is transferred from the latch unit 106, in the frame memory 104. Moreover, the frame memory control unit 105 controls reading of current-frame display data 119, which is obtained by twice reading display data written from the latch unit 107 in the frame memory 104, and previous-frame display data 120 that represents a frame immediately preceding a frame represented by the current frame display data 119 and is utilized by the motion-picture enhancement processing unit 108.

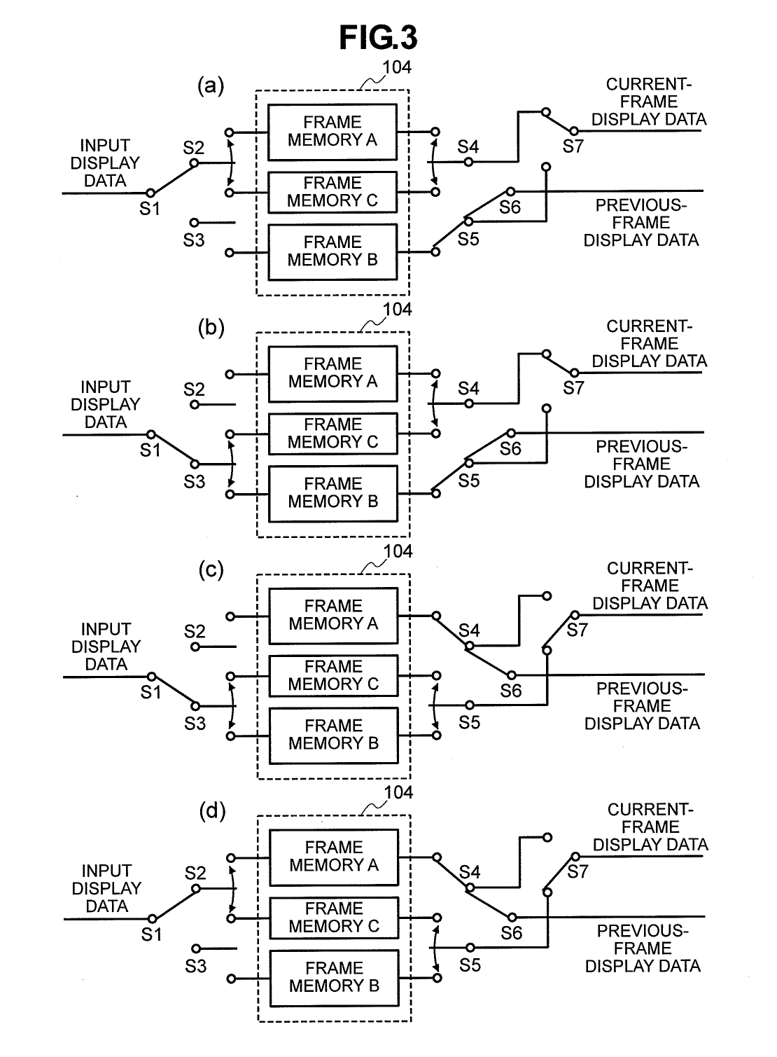

FIG. 3A to FIG. 3D are explanatory diagrams showing the configuration of the frame memory 104 to be controlled by the frame memory control unit 105 shown in FIG. 1, and the operations of the frame memory. FIG. 3A shows the operation of the frame memory 104 performed during the frame period T1 shown in FIG. 2. The high-order bits F1′ of input display data F1 and the low-order bits F1″ thereof are written through switches S1 and S2. The high-order bits F1′ are sequentially written as high-order bits A in a frame memory A, and the low-order bits F1″ are sequentially written as low-order bits C in a frame memory C. During a field A after the elapse of one field, current-frame display data F1 is read from the frame memories A and C through switches S4 and S7 at a rate that is twice higher. Moreover, the high-order bits F0′ of previous-frame display data already written in a frame memory B are read at the twice higher rate.

FIG. 3B and FIG. 3C show the operation of the frame memory 104 performed during a frame period T2 shown in FIG. 2. In FIG. 3B, the high-order bits F2′ of input display data F2 and the low-order bits F2″ thereof are written through switches S1 and S3. The high-order bits F2′ are sequentially written as high-order bits B in the frame memory B, and the low-order bits F2″ are sequentially written as low-order bits C in the frame memory C. Concurrently, current-frame display data F1 is read from the frame memories A and C through the switch S4 and a switch S7 at the twice higher rate, and the high-order bits F0′ of previous-frame display data already written in the frame memory B are read at the twice higher rate. During the field A after the elapse of a field B, current-frame display data F2 is, as shown in FIG. 3C, read from the frame memories B and C through a switch S5 and the switch S7 at the twice higher rate. Moreover, the high-order bits F1′ of previous-frame display data already written in the frame memory A are read at the twice higher rate.

FIG. 3D shows the operation of the frame memory 104 performed during a frame period T3 shown in FIG. 2. In FIG. 3D, the high-order bits F3′ of input display data F3 and the low-order bits F3″ thereof are written through the switches S1 and S2. The high-order bits F3′ are sequentially written as high-order bits A in the frame memory A, and the low-order bits F3″ are sequentially written as low-order bits C in the frame memory C. Concurrently, current-frame display data F2 is read from the frame memories B and C through the switches S5 and S7 at the twice higher rate. Moreover, the high-order bits F1′ of previous-frame display data already written in the frame memory A are read at the twice higher rate. During the field A after the elapse of the field B, current-frame display data F3 is, as shown in FIG. 3A, read from the frame memories A and C through the switches S4 and S7 at the twice higher rate. Moreover, the high-order bits F2′ of previous-frame display data already written in the frame memory B are read at the twice higher rate.

Thereafter, the above operations are repeated. The motion-picture enhancement processing unit 108 produces display data 122, which has the current-frame display data 119 enhanced, on the basis of the previous-frame display data 120 and an enhancement parameter 121.

Conventionally, in order to read the previous-frame display data 120 synchronously with the current-frame display data 119, even after the current-frame display data 119 is read, the low-order bits of the previous-frame display data 120 have to be held in the frame memory 104. However, as for the previous-frame display data 120 to be utilized by the motion-picture enhancement processing unit 108, the high-order-bit data thereof that greatly dominates a gray level is important. Even if the low-order bits thereof that little dominate the gray level are not referenced, the adverse effect is limited. Specifically, an amount of gray-scale data contained in the previous-frame display data 120 is made smaller than an amount of gray-scale data contained in the current-frame display data 119 (assuming that the number of gray-scale bits contained in the current-frame display data 120 is M, the number of gray-scale bits contained in the previous-frame display data is L. That is, M>L). Thus, the memory capacity of the frame memory 104 is reduced. A reduction in traffic makes it possible to decrease a memory transfer rate.

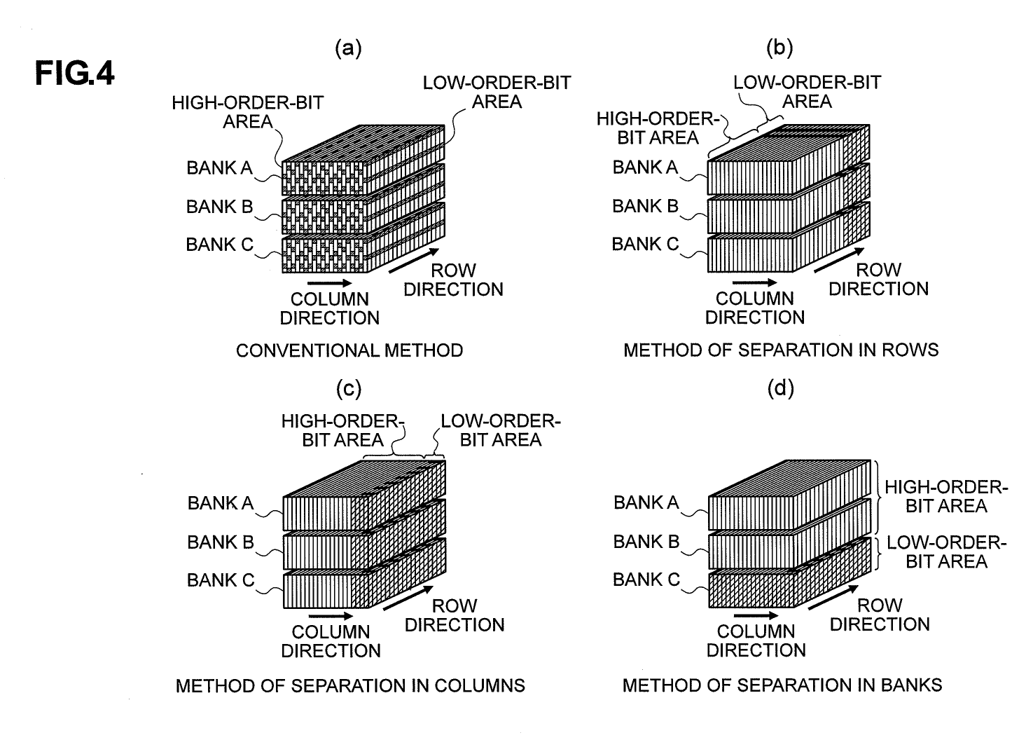

FIG. 4A shows a conventional address map conceivably attained for transfer of display data to the frame memory 104. The memory address map is depicted by expressing each bank as a block having column addresses allocated in a horizontal direction and row addresses allocated in a depth direction. When display data is sequentially transferred to the memory and stored therein, the high-order bits and low-order bits coexist at column addresses, and cannot therefore be controlled independently of each other.

In the present embodiment, when display data is written in the frame memory 104, L high-order bits of each of the current-frame display data 119 and previous-frame display data 120, and the low-order bits (M-L) of the current-frame display data 119 alone are stored in different memory areas for fear they may coexist in the same control area. This is intended to control the high-order bits and low-order bits independently of each other.

An amount of data to be handled during one reading/writing operation involving the frame memory 104 depends on the designation of a data bus width in an employed memory IC and a burst length to be handled continuously. For example, assuming that an SDRAM having a 32-bit bus is adopted as the frame memory 104 and a burst length is set to 4 bursts, data of 128 bits long (32×4=128) is written in response to one write command. Therefore, the amount of data equivalent to 128 bits is considered as a minimum unit for efficient data transfer.

FIG. 4B shows an address map employed in the present embodiment. The memory address map is depicted by expressing each bank as a block having column addresses allocated in a horizontal direction and row address allocated in a depth direction. The high-order bits and low-order bits of a data group to be handled with one issuance of a write command and read command are, unlike those shown in FIG. 3A, not mixed. In FIG. 4B, a high-order-bit area and a low-order-bit area are separated from each other in row addresses. When the areas are separated from each other in row addresses, accesses to the high-order-bit area and low-order-bit area are evenly gained during each frame so that the memory areas can be efficiently utilized. Consequently, a control sequence can be concisely constructed.

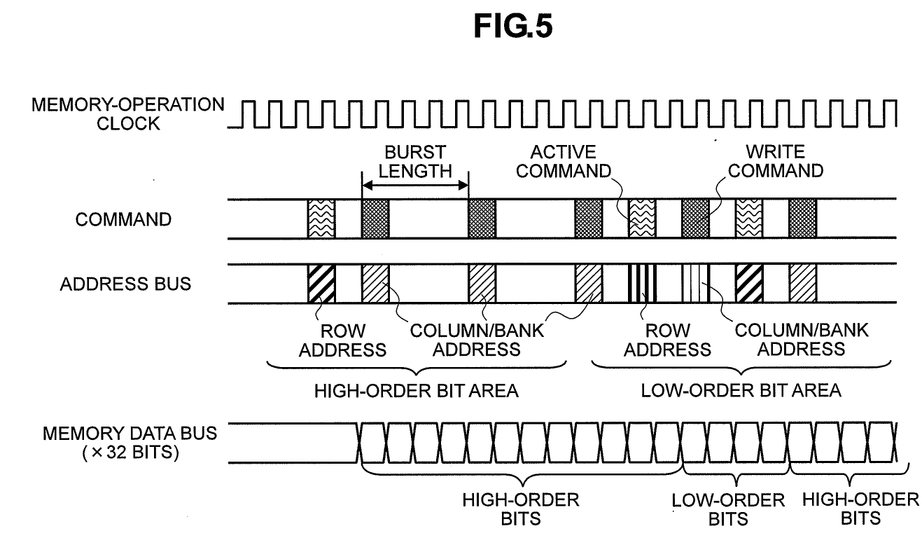

FIG. 5 is a command production timing chart for frame memory control. The axis of abscissas indicates times. Assuming that an SDRAM having a 32-bit bus is, as mentioned above, adopted as the frame memory 104 and a burst length is set to 4 bursts, a row address indicating an area in which data is written is first designated with an active command in order to write data that will be continuously transferred. Along with transfer of data to be written, a write command is issued in order to designate the leading ones of bank addresses and column addresses indicating an area in which data is are written. Every time when one burst is completed, the write command is issued together with a bank address and a column address indicating an area in which data is written. Thus, data can be continuously processed. Moreover, when each command is issued, temporal restrictions are imposed on issuance of the next command, though it depends on a memory IC. Control is therefore required to satisfy the restrictions, and an overhead has to be taken into account in data transfer.

The latch unit 106 shown in FIG. 1 not only rearranges bits of data so as to match the bit pattern of the input display data 114 with the bit pattern in the frame memory 104 but also rearranges bits of data so as to store high-order bits and low-order bits in different areas. Synchronously with the memory write control command 116, the high-order bits of data are written in the high-order-bit area and the low-order bits thereof are written in the low-order-bit area.

When the current-frame display data 119 is read from the frame memory 104, data of the high-order bits and data of the low-order bits, which are associated with the high-order bits and stored in a memory area different from a memory area in which the high-order bits are stored, are read in response to the memory read control command 118. When the previous-frame display data 120 is read, data of the high-order bits alone is read from a high-order-bit area different from the high-order-bit area from which the current-frame display data 119 is read.

For example, assuming that bits F2′ are read as the high-order bits B shown in FIG. 2 and bits F2″ are read as the low-order bits C, and that bits F2 are read as the current-frame display data 119, bits F1′ are read from the high-order bits A as the previous-frame display data 120.

According to the conventional method of writing data in the same control area that undergoes memory read control, even when the previous-frame display data 120 is read, the unnecessary low-order bits are read together with the high-order bits over two successive frames. The use efficiency of memory areas and the efficiency in data transfer are degraded. According to the present invention, since high-order bits and low-order bits are stored in different memory areas, the memory areas can be efficiently utilized. Moreover, data transfer to be performed in vain is eliminated. Consequently, an inexpensive slow-operation memory IC can be adopted as a frame memory for a high-resolution video signal whose data transfer is performed at a high rate, or a system configuration including a small number of memory ICs can be adopted. Eventually, the cost of the display device can be minimized.

The latch unit 107 rearranges the bits of display data, which are rearranged to be written in the frame memory by the latch unit 106, in line with a format in which the display data is processed in a block on a succeeding stage, and hands the current-frame display data 119 and previous-frame display data 120 to the motion-picture enhancement processing unit 108.

The motion-picture enhancement processing unit 108 references the current-frame display data 119 and previous-frame display data 120 to extract a motion picture, processes the current-frame display data 119 according to a change in display data and the enhancement parameter 121 stored in the designation holding unit 110, and outputs enhanced display data 122 having the change enhanced. This technique has been used to raise the response speed of a liquid crystal mounted in a liquid crystal display device. The enhancement parameter 121 employed herein should preferably be predetermined in consideration of a transition in a gray scale, the characteristics of the liquid crystal display panel, a driving voltage application time for the liquid crystal, ambient temperature, a pixel voltage variation time, and other factors. The above enhancement processing may be defined in the form of an arithmetic expression by utilizing the enhancement parameter 121, or may be defined in the form of a lookup table using the enhancement parameter 121 as an index. In the present embodiment, since an input frame frequency is made n times higher and gray-scale processing is performed during each of n fields, the enhancement parameter 121 providing an appropriate result of motion-picture enhancement in which luminance conceived based on input display data can be faithfully reproduced and a deviation in colors is limited should preferably be designated in relation to each field.

The gray-level transformation processing unit 109 performs transformation, which is designated with a gray-scale parameter 123 stored in the designation holding unit 110, on the enhanced display data 122 outputted from the motion-picture enhancement processing unit 108, and thus produces gray-level transformed display data 124. Herein, the gray-scale parameter 123 is prepared in relation to each of n fields, whereby a facility of satisfactorily achieving driving for motion-picture display, a facility of increasing the number of gray levels represented by input display data, and a facility of adjusting a gray-scale characteristic can be implemented. The gray-scale parameter 123 should preferably be determined in consideration of the number of divisions or fields of a frame, the characteristics of a liquid crystal panel, a driving voltage application time for a liquid crystal, ambient temperature, a pixel voltage variation time, and other factors. The gray-scale processing may be defined in the form of an arithmetic expression using the gray-scale parameter 123, or may be defined in the form of a lookup table using the gray-scale parameter 123 as an index.

In the present embodiment, an input frame period is bisected into two fields (n=2) . The gray scale characteristic for one field is shifted to relate to a higher luminance side than a desired display gray-scale characteristic does, and the gray-scale characteristic for the other field is shifted to relate to a lower luminance side than the desired display gray-scale characteristic does. The gray-scale parameters 123 for the respective fields are determined so that the combination of the gray-scale characteristics for the two fields will be matched with the desired display gray-scale characteristic. Thus, impulse type display can be realized on a hold type display device such as a liquid crystal display device with a decrease in luminance suppressed. The bisectional driving is a conventionally known driving method capable of providing satisfactory display by minimizing a motion blur in a motion picture.

The drive circuit timing production unit 111 produces a data line drive circuit control signal group 125 for use in controlling the data line drive circuit 101, output display data 126, and a scan line drive circuit control signal group 127 for use in controlling the scan line drive circuit 102. The drive circuit timing generation unit 111 receives as an input the output timing signal group 116 outputted from the output timing production unit 103, and also receives as an input the gray-level transformed display data 124 outputted from the gray-level transformation processing unit 109. Using the output timing signal group 116 and gray-level transformed display data 124, the drive circuit timing production unit 111 produces the data line drive circuit control signal group 125, output display data 126, and scan line drive circuit control signal group 127. The data line drive circuit control signal group 125 includes, for example, an output timing signal that defines the output timing of a gray-level voltage based on display data, an alternating signal that determines the polarity of a source voltage, and a clock signal synchronous with the display data. Moreover, the scan line drive circuit control signal group 127 includes, for example, a shift signal that defines a scan period for one line, and a vertical start signal that defines the beginning of scanning the leading line.

The data line drive circuit 101 develops a potential, which is associated with the number of display gray levels, using a reference voltage 128, selects a potential for one level represented by the output display data 126, and feeds a data voltage of the potential value to the liquid crystal display panel 100. Reference numeral 129 denotes the data voltage produced by the data line drive circuit, and reference numeral 130 denotes a scan line selection signal.

The scan line drive circuit 102 produces the scan line selection signal 130 on the basis of the scan line drive circuit control signal group 127, and outputs the scan line selection signal 130 to any of the scan lines in the liquid crystal display panel 100.

Each of pixels 113 in the liquid crystal display panel 100 includes a thin-film transistor (TFT) composed of a source electrode, a gate electrode, and a drain electrode, a liquid crystal layer, and an opposite electrode. When the scan line selection signal is applied to the gate electrode, a TFT switching operation is performed. When the TFT is turned on, the data voltage is written in the source electrode connected to one side of the liquid crystal layer via the drain electrode. When the TFT is turned off, the voltage written in the source electrode is sustained. The voltage in the source electrode shall be a voltage Vs, and the opposite electrode voltage shall be a voltage Vcom. The liquid crystal layer changes the polarizing direction from one to another on the basis of a potential difference between the source electrode voltage Vs and opposite electrode voltage Vcom. When light emitted from a backlight disposed on the reverse side passes through sheet polarizers disposed on the upper and lower sides of the liquid crystal layer, an amount of transmitted light is varied to achieve gray-scale display.

When the display device is constructed as mentioned above, a driving method in which motion picture enhancement intended to suppress the cost of the frame memory and gray-level transformation are combined can be implemented. Satisfactory display can be provided with a motion blur in a motion picture minimized.

### Embodiment 2

The present embodiment and the embodiment 1, as shown in FIG. 4C, are different from each other in a way of separating a high-order-bit area from a low-order-bit area and in address control by the frame memory control unit 105.

In FIG. 4C, a high-order-bit area and a low-order-bit area are separated from each other in column addresses for fear the high-order bits and low-order bits of a data group to be handled with one issuance of a write command and read command may be, like those in FIG. 4A, mixed. FIG. 4C shows, similarly to FIG. 4B, a memory address map in which each bank is expressed as a block having column addresses allocated in a horizontal direction and row address allocated in a depth direction.

When a general-purpose product such as a memory IC is adopted as the frame memory 104, a memory capacity needed to store data is smaller than a memory capacity offered by the memory IC. In contrast, when data transfer to or from a memory occurs frequently, since high-rate transfer is needed, an expensive memory IC may have to be utilized. In this case, when read control and write control are performed on an entire screen during each horizontal period, since the high-order-bit area and low-order-bit area are separated from each other in column addresses, production of an active command that is a command for designating a row address or a bank address can be suppressed in the extension of the control performed during the horizontal period. An overhead time to be spent due to restrictions on command production can be saved, and data transfer can be efficiently achieved.

### Embodiment 3

The present embodiment and the embodiment 1 are, as shown in FIG. 4D, different from each other in the way of separating a high-order-bit area from a low-order-bit area and in address control by the frame memory control unit 105.

In FIG. 4D, the high-order-bit area and low-order-bit area are separated from each other in bank addresses for fear the high-order bits and low-order bits of a data group to be handled with one issuance of a write command and read command may be, like those shown in FIG. 4A, mixed. FIG. 4D shows, similarly to FIG. 4B, a memory address map in which each bank is expressed as a block having column addresses allocated in a horizontal direction and row addresses allocated in a depth direction.

When a memory IC supporting a multi-bank operation, such as, an SDRAM is adopted as the frame memory 104, if a high-order-bit area and a low-order-bit area are separated from each other in bank addresses, since two banks can be activated simultaneously, an overhead time can be saved. Moreover, read control and write control can be independently performed on the high-order bits and low-order bits. Consequently, data transfer can be performed efficiently. Moreover, even when a memory IC that does not support the multi-bank operation is adopted, several memory ICs may be substituted for banks.

During one frame period, data is entirely stored in the frame memory in order to make a frame frequency n times higher. Some necessary bits are stored over two frame periods, and used as previous-frame display data. As an example of a display device adopting this kind of memory access, a liquid crystal display device intended to alleviate a motion blur in a motion picture has been described. The present invention is not limited to the display device. The present invention can be adapted to a display device in which entire data is temporarily stored in a frame memory and necessary bits alone are utilized for an independent purpose, for example, a display device supporting three-dimensional interlace-progressive (I-P) conversion processing and motion-picture enhancement processing (three-dimensional I-P conversion processing requires all frame data items, but motion-picture enhancement processing needs, similarly to the embodiments 1 to 3, only high-order bits, which greatly dominate a gray level, to exert a satisfactory effect), and a display device that utilizes a motion vector to perform frame interpolation (although frame data items for two or more frames are needed to calculate a motion vector, the weight of frame data in an arithmetic operation of frame prediction shrinks as the frame recedes farther from a current frame).

What is claimed is:

1. A display device including a display panel that has pixels disposed in the form of a matrix in association with intersections between a plurality of data lines and a plurality of scan lines, a data line drive circuit that outputs a display signal corresponding to input display data to any of the pixels, and a scan line drive circuit that outputs a selection signal for use in selecting a pixel which should receive the display signal, comprising:
a memory unit in which input display data for one frame period is written and from which written display data is read a plurality of times during one frame period; and
a control unit that controls an amount of input display data written in the memory unit and an amount of display data to be read a plurality of times so that the amount of input display data and the amount of display data will be different from each other.

2. The display device according to claim 1, wherein:
the memory unit stores current-frame input display data and previous-frame input display data;
the control unit divides one frame period into n (where n denotes an integer equal to or larger than 2) periods, and reads the current-frame input display data and previous-frame input display data from the memory unit over the division periods;
a motion-picture enhancement processing unit that transforms current-frame display data according to the current-frame display data and previous-frame display data read over the n periods, and a gray-level transformation processing unit that transforms each of the n parts of the current-frame display data are included; and
the current-frame display data is the whole of input display data, and the previous-frame display data is data smaller in an amount than the whole of the input display data.

3. The display device according to claim 2, wherein the previous-frame display data includes only L high-order bits (where L denotes an integer equal to or larger than 1) that greatly dominate a gray level.

4. The display device according to claim 2, wherein the memory unit includes a memory area in which the high-order bits of input display data and the low-order bits thereof are stored, and a memory area in which the high-order bits of the previous-frame display data are stored.

5. The display device according to claim 4, wherein the memory areas are separated from each other in column addresses in the memory unit.

6. The display device according to claim 4, wherein the memory areas are separated from each other in row addresses in the memory unit.

7. The display device according to claim 4, wherein the memory areas are separated from each other in bank addresses in the memory unit.

8. The display device according to claim 4, wherein the memory areas are separated from each other using different memory units.

9. A display device comprising:
a display panel having pixels disposed in the form of a matrix in association with intersections between a plurality of data lines and a plurality of scan lines;
a data line drive circuit that outputs a display signal corresponding to input display data to any of the pixels;
a scan line drive circuit that outputs a selection signal for use in selecting a pixel which should receive the display signal;
a memory unit; and
a control unit that writes display data for one frame period in the memory unit, and reads the display data from the memory unit over division periods, that is, n (where n denotes an integer equal to or larger than 2) periods into which one frame period is divided, wherein:
the control unit reads the high-order bits of the display data and the low-order bits thereof from the memory unit during a certain division period, and reads the high-order bits of the display data from the memory unit during the other division period.

10. A display device comprising:
a display panel having pixels disposed in the form of a matrix in association with intersections between a plurality of data lines and a plurality of scan lines;
a data line drive circuit that outputs a display signal corresponding to input display data to any of the pixels;
a scan line drive circuit that outputs a selection signal for use in selecting a pixel which should receive the display signal;
a memory unit;
a control unit that writes display data for one frame period in the memory unit, reads current-frame display data and previous-frame display data from the memory unit over division periods, that is, n (where n denotes an integer equal to or larger than 2) periods into which one frame period is divided; and
a transformation processing unit that transforms current-frame display data according to the current-frame display data and previous-frame display data read over the n periods, wherein:
when reading as the current-frame display data, the control unit reads the high-order bits of the display data and the low-order bits thereof from the memory unit; and
when reading as the previous-frame display data, the control unit reads the high-order bits of the display data from the memory unit.
